(19) United States
(12) Patent Application Publication
(10) Pub. No.: US 2022/0059814 A1
(43) Pub. Date: Feb. 24, 2022

(54) ANODE ELECTRODE STRUCTURE, LITHIUM-ION BATTERY, METHOD OF MAKING AN ANODE ELECTRODE STRUCTURE, METHOD OF MAKING A LITHIUM-ION BATTERY, AND SUBSTRATE PROCESSING SYSTEM FOR PRODUCING AN ANODE ELECTRODE STRUCTURE

(71) Applicant: Applied Materials, Inc., Santa Clara, CA (US)

(72) Inventor: Roland TRASSL, Giessen (DE)

(21) Appl. No.: 17/397,692

(22) Filed: Aug. 9, 2021

Related U.S. Application Data
(60) Provisional application No. 63/068,811, filed on Aug. 21, 2020.

(51) Int. Cl. H01M 4/134; H01M 4/66; H01M 4/1395; H01M 4/04; H01M 10/0525

(52) U.S. Cl. CPC H01M 4/134; H01M 4/667; H01M 4/661; H01M 2004/021; H01M 4/0423; H01M 10/0525; H01M 4/1395

(57) ABSTRACT

An anode electrode structure (10) is described. The anode electrode structure (10) includes a substrate (11) having a first surface (111) and an opposite second surface (112), a first lithium film (12) provided on the first surface (111), and a second lithium film (13) provided on the second surface (112). Further, the anode electrode structure (10) includes a first interface film (14) provided on the first lithium film (12) and a second interface film (15) provided on the second lithium film (13). The first interface film (14) and the second interface film (15) are lithium-ion conducting. Further, a lithium-ion battery having an anode electrode structure according to the present disclosure, methods of making an anode electrode structure and a lithium-ion battery, as well as a substrate processing system for producing an anode electrode structure are described.

### TECHNICAL FIELD

Embodiments of the present disclosure relate to anode electrode structures for batteries and batteries having such anode electrode structures. In particular, embodiments of the present disclosure relate to anode electrode structures for lithium-ion batteries and lithium-ion batteries having such anode electrode structures and methods of making the same. Further embodiments of the present disclosure relate to substrate processing systems, particularly roll-to-roll processing systems, for producing anode electrode structures as described in the present disclosure.

### BACKGROUND

Rechargeable electrochemical storage systems are currently becoming increasingly valuable for many fields of everyday life. High-capacity electrochemical energy storage devices, such as lithium-ion (Li-ion) batteries, are used in a growing number of applications, including portable electronics, medical, transportation, grid-connected large energy storage, renewable energy storage, and uninterruptible power supply (UPS). Traditional lead/sulfuric acid batteries often lack the capacitance and are often inadequately cycleable for these growing applications. Lithium-ion batteries, are thought to have the best chance.

Typically, lithium-ion batteries do not contain any metallic lithium for safety reasons but instead use a graphitic material as the anode. However, the use of graphite, which, in the charged state can be charged up to the limit composition LiC₆, results in a much lower capacity, in comparison with the use of metallic lithium. Currently, the industry is moving away from graphitic-based anodes to silicon-blended graphite to increase energy cell density. However, silicon blended graphite anodes suffer from first cycle capacity loss. Thus, there is a need for lithium metal deposition to replenish first cycle capacity loss of silicon blended graphite anodes. The first-cycle loss is also an issue with Si anodes, but can be compensated by applying additional Li before cycling, the so-called pre-lithiation. Another issue is swelling, i.e. volume expansion during charge/discharge (up to 400%) which needs to be solved. However, lithium metal faces several device integration challenges.

Lithium is an alkali metal. Like the heavy element homologs of the first main group, lithium is characterized by a strong reactivity with a variety of substances. Lithium reacts violently with water, alcohols and other substances that contain protic hydrogen, often resulting in ignition. Lithium is unstable in air and reacts with oxygen, nitrogen and carbon dioxide. Lithium is normally handled under an inert gas atmosphere (noble gases such as argon) and the strong reactivity of lithium necessitates that other processing operations also be performed in an inert gas atmosphere. Further, it is to be noted that lithium reacts heavily in the presence of water. When no water is present, like in a dry room, the reaction with O₂, N₂ and other gases is slow at room temperature. Accordingly, from a safety point of view, there is no issue when handled in dry atmosphere. However, some reaction still occurs on the surface which is undesired as a surface that is integrated into a battery. Accordingly, lithium provides several challenges when it comes to processing, storage, and transportation.

Accordingly, there is a demand for providing improved anode electrode structures for lithium-ion batteries, improved lithium-ion batteries, and improved methods for making anode electrode structures and lithium-ion batteries as well as improved processing systems for fabricating such anode electrode structures which overcome at least some of the problems of the state of the art.

### SUMMARY

In light of the above, an anode electrode structure, a lithium-ion battery, a method of making an anode electrode structure, a method of making a lithium-ion battery, and a substrate processing system for producing an anode electrode structure according to the independent claims are provided. Further aspects, advantages, and features are apparent from the dependent claims, the description, and the accompanying drawings.

According to an aspect of the present disclosure, an anode electrode structure is provided. The anode electrode structure includes a substrate having a first surface and an opposite second surface. A first lithium film is provided on the first surface. A second lithium film is provided on the second surface. Further, the anode electrode structure includes a first interface film provided on the first lithium film and a second interface film provided on the second lithium film. The first interface film and the second interface film are lithium-ion conducting.

According to a further aspect of the present disclosure, a lithium-ion battery is provided. The lithium-ion battery includes an anode having an anode electrode structure including a substrate having a first surface and an opposite second surface. A first lithium film is provided on the first surface. A second lithium film is provided on the second surface. Further, the anode electrode structure includes a first interface film provided on the first lithium film and a second interface film provided on the second lithium film. The first interface film and the second interface film are lithium-ion conducting. In particular, the anode electrode structure is an anode electrode structure according to any embodiments described herein.

According to another aspect of the present disclosure, a method of making an anode electrode structure is provided. The method includes coating a first surface of a substrate with a first lithium film. Additionally, the method includes coating an opposite second surface of the substrate with a second lithium film. Further, the method includes coating a first interface film on the first lithium film. Moreover, the method includes coating a second interface film on the second lithium film. The first interface film and the second interface film are lithium-ion conducting.

According to a further aspect of the present disclosure, a method of making a lithium-ion battery is provided. The method includes combining an anode electrode structure according to any embodiments described herein with a cathode electrode structure. Further, the method includes providing a separator positioned between the anode electrode structure and the cathode electrode structure.

According to another aspect of the present disclosure, a substrate processing system for producing an anode electrode structure is provided. The substrate processing system includes a first vacuum deposition chamber having a first coating drum configured for guiding a flexible substrate past one or more first deposition units having at least one lithium deposition unit. Additionally, the processing system includes a second vacuum deposition chamber having a second coating drum configured for guiding the flexible substrate past one or more second deposition units having at least one lithium deposition unit. Further, the processing system includes a transportation system configured for transporting the flexible substrate such that a front side of the flexible substrate faces the one or more first deposition units and a backside of the flexible substrate faces the one or more second deposition units.

Embodiments are also directed at apparatuses for carrying out the disclosed methods and include apparatus parts for performing each described method aspect. These method aspects may be performed by way of hardware components, a computer programmed by appropriate software, by any combination of the two or in any other manner. Furthermore, embodiments according to the disclosure are also directed at methods for operating the described apparatus. The methods for operating the described apparatus include method aspects for carrying out every function of the apparatus.

### BRIEF DESCRIPTION OF THE DRAWINGS

So that the manner in which the above recited features of the present disclosure can be understood in detail, a more particular description of the disclosure, briefly summarized above, may be had by reference to embodiments. The accompanying drawings relate to embodiments of the disclosure and are described in the following:

FIG. 1 shows a schematic view of an anode electrode structure according to embodiments described herein;

FIG. 2 shows a schematic view of an anode electrode structure according to further embodiments described herein;

FIG. 3 shows a schematic view of a lithium-ion battery according to embodiments described herein;

FIG. 4 shows a schematic view of a lithium-ion battery according to embodiments further described herein;

FIG. 5 shows a block diagram for illustrating a method of making an anode electrode structure according to embodiments described herein;

FIG. 6 shows a block diagram for illustrating a method of making a lithium-ion battery according to embodiments described herein; and

FIG. 7 shows a schematic view of a substrate processing system for producing an anode electrode structure according to embodiments described herein.

### DETAILED DESCRIPTION OF EMBODIMENTS

Reference will now be made in detail to the various embodiments of the disclosure, one or more examples of which are illustrated in the figures. Within the following description of the drawings, same reference numbers refer to same components. Only the differences with respect to individual embodiments are described. Each example is provided by way of explanation of the disclosure and is not meant as a limitation of the disclosure. Further, features illustrated or described as part of one embodiment can be used on or in conjunction with other embodiments to yield yet a further embodiment. It is intended that the description includes such modifications and variations.

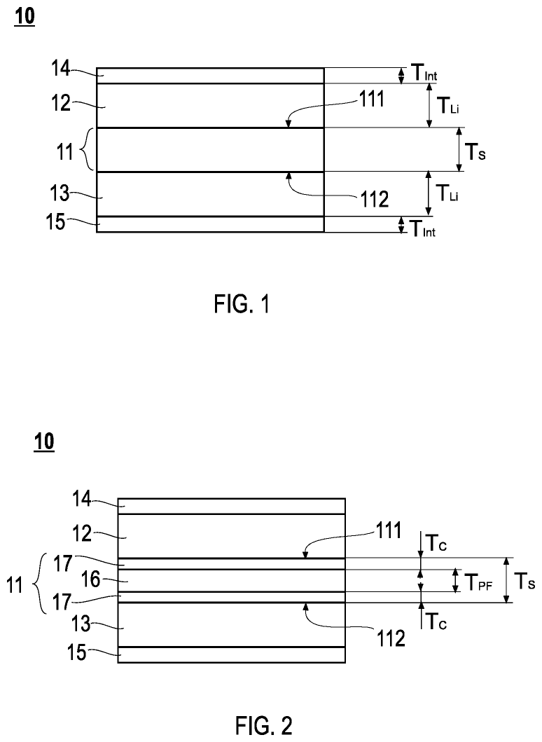

With exemplary reference to FIG. 1, an anode electrode structure 10 according to the present disclosure is described. According to embodiments, which can be combined with any other embodiments described herein, the anode electrode structure 10 includes a substrate 11 having a first surface 111 and an opposite second surface 112. A first lithium film 12 is provided on the first surface 111. A second lithium film 13 is provided on the second surface 112. In particular, the first lithium film 12 is in direct contact with the first surface 111 of the substrate and the second lithium film 13 is in direct contact with the second surface 112 of the substrate 11. Additionally, the anode electrode structure 10 includes a first interface film 14 provided on the first lithium film 12. Further, the anode electrode structure 10 includes a second interface film 15 provided on the second lithium film 13. In particular, the first interface film 14 is in direct contact with the first lithium film 12 and the second interface film 15 is in direct contact with the second lithium film 13. The first interface film 14 and the second interface film 15 are lithium-ion conducting.

Accordingly, compared to the state of the art, an improved anode electrode structure for lithium-ion batteries is provided. In particular, the anode electrode structure as described herein provide for a higher energy density than conventional anode electrode structures. More specifically, embodiments as described herein provide for a higher power to weight ratio (Wh/kg) and a higher power to anode thickness T_{A} ratio (Wh/T_{A}). Further, embodiments of the anode electrode structure, as described herein can be produced at lower cost and are improved with respect to safety aspects.

Before various further embodiments of the present disclosure are described in more detail, some aspects with respect to some terms used herein are explained.

In the present disclosure, an “anode electrode structure” can be understood as a structure configured for being used as an anode electrode, particularly for lithium-ion batteries. In particular, an “anode electrode structure” according to the present disclosure can be understood as a structure having multiple layers, also referred to as a layer stack. More specifically, the anode electrode structure of the present disclosure typically includes a substrate, particularly a flexible substrate, having one or more film or coatings provided on both sides of the substrate.

In the present disclosure, a “substrate” is typically a flexible substrate. A “flexible substrate” can be understood as a bendable substrate. The term “flexible substrate” or “substrate” may be synonymously used with the term “foil” or the term “web”. In particular, it is to be understood that embodiments of the processing system described herein can be utilized for processing any kind of flexible substrate, e.g. for manufacturing flat coatings with a uniform thickness. For example, a flexible substrate as described herein may include materials like PET, HC-PET, PE, PI, PU, TaC, OPP, CPP, one or more metals (e.g. copper or aluminum), paper, combinations thereof, and already coated substrates like Hard Coated PET (e.g. HC-PET, HC-TaC) or metal coated polymeric substrates (e.g. copper coated PET) and the like. For example, the substrate thickness can be 0.5 μm or more and 1 mm or less. Typically, the substrate thickness T_{S} of a substrate employed in an anode electrode structure as described herein is 1 μm≤T_{S}≤15 μm, particularly 3 μm≤T_{S}≤10 μm.

In the present disclosure, a “lithium film” can be understood as a film including lithium as a main component. In other words, the lithium film as described herein is made of a material having lithium as a main constituent, e.g. the lithium film may be made of a lithium alloy. In particular, the lithium film may consist of lithium. Providing an anode with a lithium film consisting of lithium, i.e. being made of a pure metallic lithium, beneficially provides for even higher energy density due to the lower weight and thickness necessary.

In the present disclosure, an “interface film” can be understood as a film of the anode electrode structure representing an interface to the surrounding of the anode electrode structure, e.g. an electrolyte of a battery

According to embodiments, which can be combined with any other embodiments described herein, at least one of the first interface film 14 and the second interface film 15, as exemplarily shown in FIG. 1, includes a lithium-ion conducting material. The lithium-ion conducting material may be selected from the group consisting of lithium-ion conducting ceramic, lithium-ion conducting glass, lithium-ion conducting polymer, composite combinations thereof, or unit layer combinations thereof. For example, the lithium-ion conducting material can be UPON (lithium phosphorus oxynitride), Al₂O₃ (aluminum oxide), Li₂CO₃ (lithium carbonate) or any other suitable lithium-ion conducting material. The first interface film 14 and the second interface film 15 may include or consist of the same lithium-ion conducting material. Alternatively, the first interface film 14 may include or consist of a different lithium-ion conducting material than the second interface film 15.

According to embodiments, which can be combined with any other embodiments described herein, the substrate 11 is a foil comprising an electrically conductive material, for example copper. In other words, the substrate 11 can be a foil comprising copper or consisting of copper. According to an example, which can be combined with other embodiments described herein, the substrate 11 is a polymeric foil 16 having a copper coating 17 on both sides of the polymeric foil 16, as exemplarily shown in FIG. 2. Typically, the substrate 11 has a thickness T_{S} of 0.5 μm≤T_{S}≤15 μm, particularly 1 μm≤T_{S}≤10 μm.

For example, in the case that a substrate consisting of copper is selected, the substrate may have a thickness of 2 μm≤T_{S}≤10 μm, particularly 4 μm≤T_{S}≤8 μm. According to another example in which a polymeric foil having a copper coating on both sides is selected, the polymeric foil may have a thickness T_{PF} of 3 μm≤T_{PF}≤12 μm, particularly 4 μm≤T_{PF}≤8 μm, and the copper coating on each side of the polymeric foil may have thickness T_{C} of 0.3 μm≤T_{C}≤2 μm, particularly 0.3 μm≤T_{C}≤1 μm.

According to embodiments, which can be combined with any other embodiments described herein, at least one of the first lithium film 12 and the second lithium film 13 has a thickness T_{Li} of 1 μm≤T_{Li}≤40 μm, particularly 3 μm≤T_{Li}≤25 μm, more particularly 5 μm≤T_{Li}≤20 μm. The thickness T_{Li} of the first and second lithium films is exemplarily indicated in FIG. 1. The first lithium film 12 and the second lithium film 13 may have the same thickness. Alternatively, the first lithium film 12 can have a different thickness than the second lithium film 13.

According to embodiments, which can be combined with any other embodiments described herein, at least one of the first interface film 14 and the second interface film 15 has a thickness T_{Int} of 0.01 μm≤T_{Int}≤10 μm, particularly 0.05 μm≤T_{Int}≤5 μm. The first interface film 14 and the second interface film 15 may have the same thickness. Alternatively, the first interface film 14 can have a different thickness than the second interface film 15.

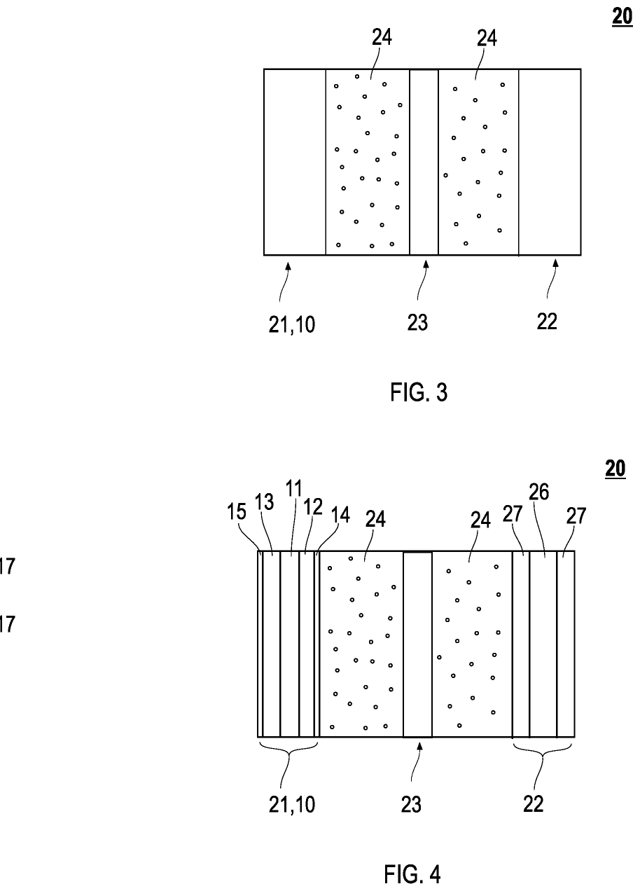

With exemplarily reference to FIG. 3, a lithium-ion battery 20 according to the present disclosure is described. The lithium-ion battery 20 typically includes two electrodes of opposing polarity, namely a negative anode 21 and a positive cathode 22. The cathode 22 and the anode 21 are insulated by a separator 23 arranged between the cathode and the anode to prevent short circuits between the cathode and the anode. Further, the battery includes an electrolyte 24 which is used as ion conductive matrix. Accordingly, the electrolyte is an ion conductor, which may be liquid, in gel form or solid. The separator is typically ion-pervious and permits an exchange of ions between the anode and cathode in a charge or discharge cycle. For example, the separator 23 can be a porous polymeric ion-conducting polymeric substrate. In particular, the porous polymeric substrate may be a multi-layer polymeric substrate.

With exemplary reference to FIGS. 1, 2 and 4, according to embodiments, which can be combined with any other embodiments described herein, the lithium-ion battery includes an anode 21 having an anode electrode structure 10 including a substrate 11 having a first surface 111 and an opposite second surface 112. A first lithium film 12 is provided on the first surface 111. A second lithium film 13 is provided on the second surface 112. Additionally, the anode electrode structure 10 includes a first interface film 14 provided on the first lithium film 12. Further, the anode electrode structure 10 includes a second interface film 15 provided on the second lithium film 13. The first interface film 14 and the second interface film 15 are lithium-ion conducting. In particular, the anode electrode structure 10 of the lithium-ion battery 20 is an anode electrode structure 10 according to embodiments described herein.

According to embodiments, which can be combined with any other embodiments described herein, the lithium-ion battery 20 includes a cathode 22 having a cathode electrode structure having a substrate including or consisting of aluminum. In particular, the substrate may include a polymeric substrate 26, particularly a polymeric foil, having an aluminum coating 27 on both sides of the polymeric foil.

For example, in the case that a substrate for the cathode consisting of aluminum is selected, the substrate may have a thickness of 8 μm≤T_{SA}≤14 μm, particularly 10 μm≤T_{SA}≤12 μm. According to another example in which a polymeric substrate having aluminum coatings on both sides is selected, the polymeric substrate may have a thickness T_{PS} of 3 μm≤T_{PS}≤12 μm, particularly 4 μm≤T_{PS}≤8 μm, and the aluminum coating on each side of the polymeric substrate may have a thickness T_{Al} of 0.5 μm≤T_{Al}≤3 μm, particularly 0.7 μm≤T_{Al}≤1.5 μm.

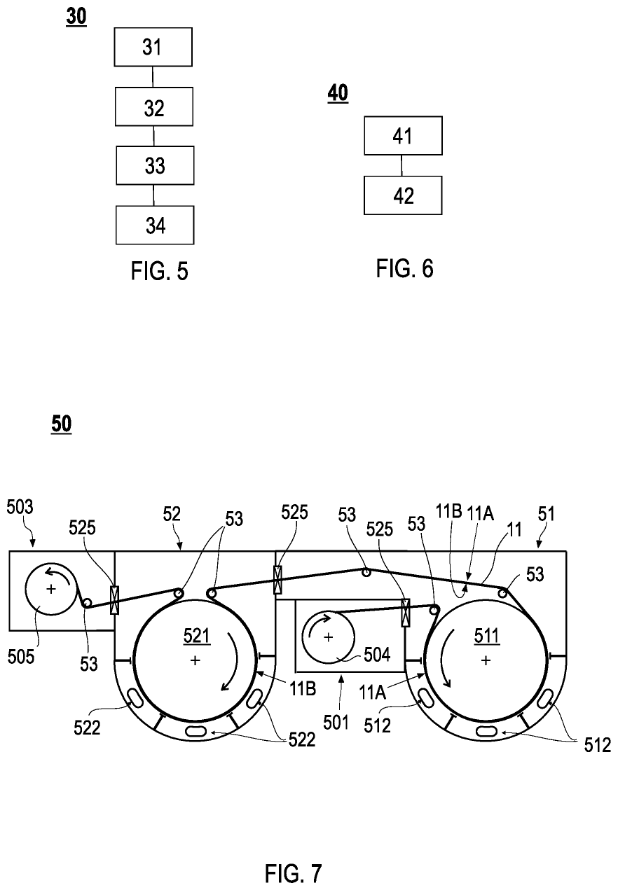

With exemplarily reference to the block diagram of FIG. 5, a method 30 of making an anode electrode structure according to the present disclosure is described. According to embodiments, which can be combined with any other embodiments described herein, the method includes coating (represented by block 31 in FIG. 5) a first surface 111 of a substrate 11 with a first lithium film 12. After coating the first surface 111 of the substrate 11 with the first lithium film 12, the first lithium film 12 may be exposed to CO₂, which can be beneficial for reducing reactivity of the first lithium film such that the first lithium film is improved with respect to stability.

Additionally, the method includes coating (represented by block 32 in FIG. 5) an opposite second surface 112 of the substrate 11 with a second lithium film 13. After coating the second surface 112 of the substrate 11 with the second lithium film 13, second lithium film 13 may be exposed to CO₂, which can be beneficial for reducing reactivity of the second lithium film such that the second lithium film is improved with respect to stability.

Further, the method 30 includes coating (represented by block 33 in FIG. 5) a first interface film 14 on the first lithium film 12. Moreover, the method includes coating (represented by block 34 in FIG. 5) a second interface film 15 on the second lithium film 13. The first interface film 14 and the second interface film 15 are lithium-ion conducting. It is to be understood, that first the first lithium film 12 and the second lithium film 13 and then the first interface film 14 and the second interface film 15 may be deposited. Alternatively, first interface film 14 may be deposited directly after depositing the first lithium film 12, and then the second lithium film 13 is deposited and subsequently the second interface film 15 is deposited.

According to embodiments of the method 30, which can be combined with any other embodiments described herein, the substrate 11 is a foil including or consisting of an electrically conductive material. For example, the substrate 11 can be a copper foil. Alternatively, the substrate 11 can be a polymeric foil having a copper coating 17 on both sides of the polymeric foil, as described herein.

It is to be understood that in the method 30 of making an anode electrode structure, the first lithium film 12 can be a first lithium film according to embodiments described herein, the second lithium film 13 can be a second lithium film according to embodiments described herein, the first interface film 14 can be a first interface film according to embodiments described herein, and the second interface film 15 can be a second interface film according to embodiments described herein.

Further, it is to be understood that the method 30 of making an anode electrode structure can be conducted by using a roll-to-roll processing system, as exemplarily described with reference to FIG. 7.

With exemplarily reference to the block diagram of FIG. 6, a method 40 of making a lithium-ion battery according to the present disclosure is described. According to embodiments, which can be combined with any other embodiments described herein, the method 40 includes combining (represented by block 41 in FIG. 6) an anode electrode structure 10 according to any embodiments described herein with a cathode electrode structure. Additionally, the method includes providing (represented by block 42 in FIG. 6) a separator positioned between the anode electrode structure and the cathode electrode structure. Further, the method typically includes providing an electrolyte as described herein.

According to embodiments of the method 40 of making the lithium-ion battery, which can be combined with any other embodiments described herein, the cathode electrode structure includes a substrate including or consisting of aluminum, for example as described with reference to FIG. 4.

With exemplarily reference to FIG. 7, a substrate processing system 50 for producing an anode electrode structure according to the present disclosure is described.

In the present disclosure, a “substrate processing system for producing an anode electrode structure according to the present disclosure” can be understood as a processing system configured for producing anode electrode structures according to embodiments described herein. In particular, the substrate processing system is a roll-to-roll processing system for continuously processing a flexible substrate. More specifically, the processing system can be a vacuum processing system having at least one vacuum chamber, particularly two vacuum deposition chambers with deposition units for depositing material on the flexible substrate. For instance, the processing system may be configured for a substrate length of 500 m or more, 1000 m or more, or several kilometers. The substrate width can be 300 mm or more, particularly 500 mm or more, more particularly 1 m or more. Further, the substrate width can be 3 m or less, particularly 2 m or less.

According to embodiments, which can be combined with any other embodiments described herein, the substrate processing system 50 includes a first vacuum deposition chamber 51 having a first coating drum 511 configured for guiding a flexible substrate 11 past one or more first deposition units 512.

In the present disclosure, a “vacuum deposition chamber” can be understood as chamber configured to provide a vacuum within the chamber and including a deposition unit for depositing material on the substrate. The term “vacuum”, as used herein, can be understood in the sense of a technical vacuum having a vacuum pressure of less than, for example, 10 mbar.

Typically, the pressure in a vacuum chamber as described herein may be between 10 mbar and about 10⁻⁸ mbar, more typically between 10⁻⁵ mbar and 10⁻⁷ mbar, and even more typically between about 10⁻⁶ mbar and about 10⁻⁷ mbar. It is to be understood, that typically the vacuum level during processing is higher and depends on the process. For example, for the lithium deposition, the chamber pressure during processing is in the 10⁻⁵-10⁻⁴ mbar range. Directly within the Li vapor the pressure can be much higher, e.g. 1 mbar. For example, for the interface layer deposition, if the process is sputtering, the process pressure is typically in the mid 10⁻³ mbar range.

In the present disclosure, a “coating drum” can be understood as a drum or a roller having a substrate support surface for contacting the flexible substrate. In particular, the coating drum can be rotatable about a rotation axis and may include a substrate guiding region. Typically, the substrate guiding region is a curved substrate support surface, e.g. a cylindrically symmetric surface, of the coating drum. The curved substrate support surface of the coating drum may be adapted to be (at least partly) in contact with the flexible substrate during operation of the processing system.

In the present disclosure, a “deposition unit” can be understood as a unit or device configured for depositing material on a substrate, in particular a material of the films as described herein. For example, the deposition unit may be a sputter deposition unit, a CVD deposition unit, an evaporation deposition units, a PVD or PECVD deposition unit, sputter deposition unit, or another suitable deposition unit.

Additionally, as exemplarily shown in FIG. 7, the substrate processing system 50 includes a second vacuum deposition chamber 52 having a second coating drum 521 configured for guiding the flexible substrate 11 past one or more second deposition units 522. Further, the substrate processing system 50 includes a transportation system 53 configured for transporting the flexible substrate such that a front side 11A of the flexible substrate faces the one or more first deposition units 512 and a backside 11B of the flexible substrate faces the one or more second deposition units 522. Typically, the transportation system 53 includes a roller assembly configured for guiding the flexible substrate, as exemplarily shown in FIG. 7. Accordingly, a double sided coating can be provided on the flexible substrate 11.

Further, as exemplarily shown in FIG. 7, the substrate processing system 50 may include a first spool chamber 501 connected to the first vacuum deposition chamber 51, e.g. via a gap sluice 525. For instance, the first spool chamber 501 may house a storage spool 504 for providing the flexible substrate 11. Additionally, the substrate processing system 50 may include a second spool chamber 503 connected to the second vacuum deposition chamber 52, e.g. via a gap sluice 525. For instance, the second spool chamber 503 may house a wind-up spool 505 for winding the flexible substrate 11 thereon after processing.

In particular, the one or more first deposition units 512 include at least one deposition unit for depositing the first lithium film 12 on the first surface 111 of the substrate as described herein. Further, the one or more first deposition units 512 typically include at least one deposition unit for depositing a first interface film 14 on the first lithium film 12 as described herein.

Accordingly, the first surface 111 of the substrate may also be referred to as a front surface of the substrate. The one or more second deposition units 522 typically include at least one deposition unit for depositing a second lithium film 13 on the second surface 112 of the substrate 11. Further, the one or more second deposition units 522 typically include at least one deposition unit for depositing a second interface film 15 on the second lithium film 13.

It is to be understood, that alternatively the substrate processing system may include one or more coating drums for each lithium film and separate coating drums for the interface films as described herein. Accordingly, the individual processes may be spatially separated.

In view of the above, it is to be understood that compared to the state of the art, embodiments of the present disclosure beneficially provide an anode electrode structure, a lithium-ion battery, a method of making an anode electrode structure, and a method of making a lithium-ion battery which are improved compared to the state of the art. Further, a processing system for fabricating anode electrode structures as described herein is provided.

In particular, the following embodiments are described herein:

Embodiment 1: An anode electrode structure (10), comprising: a substrate (11) having a first surface (111) and an opposite second surface (112); a first lithium film (12) provided on the first surface (111); a second lithium film (13) provided on the second surface (112); a first interface film (14) provided on the first lithium film (12); and a second interface film (15) provided on the second lithium film (13), the first interface film (14) and the second interface film (15) are lithium-ion conducting.
Embodiment 2: The anode electrode structure (10) of embodiment 1, wherein at least one of the first interface film (14) and the second interface film (15) comprises a lithium-ion conducting material selected from the group consisting of lithium-ion conducting ceramic, lithium-ion conducting glass, lithium-ion conducting polymer, composite combinations thereof, or unit layer combinations thereof.
Embodiment 3: The anode electrode structure (10) of embodiment 1 or 2, wherein the substrate (11) is a foil comprising an electrically conductive material, particularly copper.
Embodiment 4: The anode electrode structure (10) of any of embodiments 1 to 3, wherein the substrate (11) is a polymeric foil (16) having a copper coating (17) on both sides of the polymeric foil (16).
Embodiment 5: The anode electrode structure (10) of any of embodiments 1 to 4, wherein the substrate (11) has a thickness T_{S} of 0.5 μm≤T_{S}≤15 μm, particularly 1 μm≤T_{S}≤10 μm.
Embodiment 6: The anode electrode structure (10) of any of embodiments 1 to 5, wherein at least one of the first lithium film (12) and the second lithium film (13) has a thickness T_{Li} of 1 μm≤T_{Li}≤40 μm, particularly 3 μm≤T_{Li}≤25 μm.
Embodiment 7: The anode electrode structure (10) of any of embodiments 1 to 6, wherein at least one of the first interface film (14) and the second interface film (15) has a thickness T_{Int} of 0.01 μm≤T_{Int}≤10 μm, particularly 0.05 μm≤T_{Int}≤5 μm.
Embodiment 8: A lithium-ion battery (20) comprising an anode (21) having an anode electrode structure (10) comprising: a substrate (11) having a first surface (111) and an opposite second surface (112); a first lithium film (12) provided on the first surface (111); a second lithium film (13) provided on the second surface (112); a first interface film (14) provided on the first lithium film (12); and a second interface film (15) provided on the second lithium film (13), the first interface film (14) and the second interface film (15) are lithium-ion conducting, particularly the anode electrode structure (10) being the anode electrode structure (10) according to any of embodiments 1 to 7.
Embodiment 9: The lithium-ion battery (20) of embodiment 8, further comprising a cathode (22) having a cathode electrode structure comprising a polymeric substrate (26) having an aluminum coating (27) on both sides of the polymeric substrate (26).
Embodiment 10: A method (30) of making an anode electrode structure, comprising coating (31) a first surface (111) of a substrate (11) with a first lithium film (12); coating (32) an opposite second surface (112) of the substrate (11) with a second lithium film (13); coating (33) a first interface film (14) on the first lithium film (12); and coating (34) a second interface film (15) on the second lithium film (13), wherein the first interface film (14) and the second interface film (15) are lithium-ion conducting.
Embodiment 11: The method (30) of embodiment 10, wherein the substrate (11) is a foil comprising an electrically conductive material, particularly wherein the substrate (11) is a polymeric foil (16) having a copper coating (17) on both sides of the polymeric foil (16).
Embodiment 12: The method (30) of embodiment 10 or 11, wherein the method is conducted by using a roll-to-roll substrate processing system (50).
Embodiment 13: A method (40) of making a lithium-ion battery, comprising combining (41) an anode electrode structure (10) according to any of embodiments 1 to 7 with a cathode electrode structure, and providing (42) a separator positioned between the anode electrode structure and the cathode electrode structure.
Embodiment 14: The method of embodiment 13, wherein the cathode electrode structure comprises a substrate comprising aluminum, particularly wherein the substrate comprises a polymeric foil having an aluminum coating (27) on both sides of the polymeric foil.
Embodiment 15: A substrate processing system (50) to produce an anode electrode structure, comprising a first vacuum deposition chamber (51) having a first coating drum (511) configured to guide a flexible substrate past one or more first deposition units (512) comprising at least one least one lithium deposition unit; a second vacuum deposition chamber (52) having a second coating drum (521) configured to guide the flexible substrate (11) past one or more second deposition units (522) comprising at least one least one lithium deposition unit; and a transportation system (53) configured to transport the flexible substrate such that a front side (11A) of the flexible substrate faces the one or more first deposition units (512) and a backside (11B) of the flexible substrate faces the one or more second deposition units (522).

While the foregoing is directed to the embodiments described herein, other and further embodiments may be devised without departing from their basic scope, and the scope is determined by the claims that follow.

1. An anode electrode structure, comprising:
a substrate having a first surface and an opposite second surface;
a first lithium film provided on the first surface;
a second lithium film provided on the second surface;
a first interface film provided on the first lithium film; and
a second interface film provided on the second lithium film, the first interface film and the second interface film are lithium-ion conducting.

2. The anode electrode structure of claim 1, wherein at least one of the first interface film and the second interface film comprises a lithium-ion conducting material selected from the group consisting of lithium-ion conducting ceramic, lithium-ion conducting glass, lithium-ion conducting polymer, composite combinations thereof, or unit layer combinations thereof.

3. The anode electrode structure of claim 1, wherein the substrate is a foil comprising an electrically conductive material.

4. The anode electrode structure of claim 1, wherein the substrate is a polymeric foil having a copper coating on both sides of the polymeric foil.

5. The anode electrode structure of claim 1, wherein the substrate has a thickness T_{S} of 0.5 μm≤T_{S}≤15 μm.

6. The anode electrode structure of claim 1, wherein at least one of the first lithium film and the second lithium film has a thickness T_{Li} of 1 μm≤T_{Li}≤40 μm.

7. The anode electrode structure of claim 1, wherein at least one of the first interface film and the second interface film has a thickness T_{Int} of 0.01 μm≤T_{Int}≤10 μm.

8. A lithium-ion battery comprising an anode having an anode electrode structure comprising:
a substrate having a first surface and an opposite second surface;
a first lithium film provided on the first surface;
a second lithium film provided on the second surface;
a first interface film provided on the first lithium film; and
a second interface film provided on the second lithium film, the first interface film and the second interface film are lithium-ion conducting.

9. The lithium-ion battery of claim 8, further comprising a cathode having a cathode electrode structure comprising a polymeric substrate having an aluminum coating on both sides of the polymeric substrate.

10. A method of making an anode electrode structure, comprising
coating a first surface of a substrate with a first lithium film;
coating an opposite second surface of the substrate with a second lithium film;
coating a first interface film on the first lithium film; and
coating a second interface film on the second lithium film, wherein the first interface film and the second interface film are lithium-ion conducting.

11. The method of claim 10, wherein the substrate is a foil comprising an electrically conductive material.

12. The method of claim 10, wherein the method is conducted by using a roll-to-roll substrate processing system.

13. A method of making a lithium-ion battery, comprising
combining an anode electrode structure according to claim 1 with a cathode electrode structure, and providing a separator positioned between the anode electrode structure and the cathode electrode structure.

14. The method of claim 13, wherein the cathode electrode structure comprises a substrate comprising aluminum.

15. A substrate processing system to produce an anode electrode structure, comprising
a first vacuum deposition chamber having a first coating drum configured to guide a flexible substrate past one or more first deposition units comprising at least one lithium deposition unit;
a second vacuum deposition chamber having a second coating drum configured to guide the flexible substrate past one or more second deposition units comprising at least one lithium deposition unit; and
a transportation system configured to transport the flexible substrate such that a front side of the flexible substrate faces the one or more first deposition units and a backside of the flexible substrate faces the one or more second deposition units.

16. The anode electrode structure of claim 1, wherein the substrate is a foil comprising copper.

17. The anode electrode structure of claim 1, wherein the substrate (11) has a thickness T_{S} of 1 μm≤T_{S}≤10 μm.

18. The anode electrode structure of claim 1, wherein at least one of the first lithium film and the second lithium film has a thickness T_{Li} of 3 μm≤T_{Li}≤25 μm.

19. The method of claim 10, wherein the substrate is a polymeric foil having a copper coating on both sides of the polymeric foil.

20. The method of claim 13, wherein the cathode electrode structure comprises a substrate that comprises a polymeric foil having an aluminum coating on both sides of the polymeric foil.
